(19) United States
(12) Patent Application Publication
(10) Pub. No.: US 2002/0159051 A1
(43) Pub. Date: Oct. 31, 2002

(54) Method for optical wavelength position searching and tracking

(76) Inventor: Mingxian Guo, Shenzhen (CN)

Correspondence Address: MERCHANT & GOULD P.C., P.O. Box 2903, Minneapolis, MN, 55402-0903, US

(21) Appl. No.: 09/845,683

(22) Filed: Apr. 30, 2001

(51) Int. Cl. G01C 1/00; G01B 11/26

(52) U.S. Cl. 356/139.04

(57) ABSTRACT

A method for optical wavelength position searching and tracking with variable step values. During the searching process, if the optical power variation detected for two times has not reached a certain amplitude, then the rapid searching method with large steps will be used; while the optical power variation has reached a certain amplitude, the step value will be modified, and the fine searching method with small steps will be used. The method provided by the present invention has been implemented in the application of optical wavelength position searching, and has achieved good results, not only the requirement for rapid the searching process is satisfied, but also accurate optical signal processing is ensured, and the processing cost has not increased.

### FIELD OF THE INVENTION

The present invention relates to an area of the automatic control technique. More particularly, it relates to a method for optical wavelength position searching and tracking with variable steps.

### BACKGROUND OF THE INVENTION

There are two methods for optical wavelength position searching and tracking in the related art. The first method is a hardware matching method. Because the optical wavelength emitting from the laser is fixed, an optical filter with the corresponding vavelength may be selected on the basis of the above wavelength, such filter is a passive filter, it can only filter the light with the coincident wavelength. But during the process of transmitting the light, the optical wavelength may be changed in a certain degree caused by the temperature variation or the fiber bending, then the light, which is filtered by the fixed optical filter, may be damaged to a certain extent. Because a software for implementing the automatic control is not required in this method, only the adequate hardware matching is needed; but the disadvantage of which is evident, that is, bad adaptability, and limited range, particularly, it will be rather unreliable while the signal is weak.

The second method in prior art is a method in which a tunable active optical filter may be used. By searching the fixed step (herein, the step refers to a voltage regulation amplitude for driving the tunable optical filter second time), the position will be set at the signal, then the voltage is used as a operating voltage for driving the tunable optical filter. During the operating, the operating voltage of the tunable optical filter may be varied slightly in every specific time interval, then the object of adapting dynamically the variation of the optical wavelength can be reached. The substantial searching and tracking processes are as follows:

1: A driving voltage may be applied to the optical filter; after passing through the optical filter, the optical power value will be recorded at this time; then a step value will be added to or subtracted from the driving voltage on the basis of the searching direction, then the optical filter will be driven again; and the optical power value after passing through the optical filter this time will be recorded again.

2: The above process may be repeated, after more than three values have been recorded, the condition decision of the recorded values will be started, after that, one decision should be performed each time a recorded value being added. The condition decision may be carried out in such a way: Taking a recorded value, then it will be compared with two values before and after it. If it is greater than both of two values before and after it, then the second decision will be performed; otherwise, the second decision will not be performed, and the process will return to process 1 to carry out continuously.

The second decision may be carried out in such a way: A value may be calculated for the middle recorded value on the basis of a ratio. If all of two values before and after the middle value are smaller than said value, then said value and the driving voltage at this time will be recorded; then the third decision may be carried out. The third decision will be carried out in such a way: the power value of said record point may be compared with the largest power value stored. If the power value is greater than the largest power value stored, then the largest power value stored will be substituted by said value, otherwise, it will return to process 1 to carry out continuously.

3: The above process will be repeated as described above, until the driving voltage excesses a sufficient range, and the searching will be ended. Then the voltage value where the largest power is obtained will be used to drive the optical filter, and the dynamic tracking process 4 will be entered.

4: The dynamic tracking processes are as follows:

4A: Firstly whether the time interval has been reached will be decided, if it has reached then the tracking process will be enabled and the process will go to 4B; if it has not reached, then whether the power has been changed will be decided, if the power has not been changed, then 4A will be repeated, if it has been changed, then the tracking process will be enabled and the process will go to 4B.

4B: By using the current voltage point as a center point, and the tracking step value as a regulation amplitude, the optical filter can be swung to a certain direction, if the power value after swinging is larger than the power value of the current operating point, then it will be continued to swing at this direction; if the power value after swinging is smaller than the power value of the current operating point, then the direction of the swing will be changed.

4C: Comparing the power value after swinging and the power value of the current operating point again, if the power value after swinging is smaller than the power value of the current operating point, then the tracking step value will be decreased, and the direction will be changed, it will be repeated continuously by starting from 4B, until the tracking step value is stable at 1, and the tracking will be ended, and the process will go to 4D; if the power value after swinging is larger than the power value of the current operating point, then the tracking step value will be increased, and it will be swung continuously at this direction, the the process will go to 4B to repeat.

4D: The above process will be repeated by starting from 4A.

The disadvantages of this method are: By using the second method, though the problems of some aspects of the first method have been solved, but new factors of unreliability may be raised, that is, when the optical signal is weak, the signal could not be searched, or only a error point can be searched.

### SUMMARY OF THE INVENTION

The object of the present invention is to provide a method for positioning the optical wavelength rapidly and accurately.

In order to solve the conflict between the rapid speed and the accuracy, a method for position searching and tracking the optical wavelength is suggested by the present invention, the key point of which is to select the different steps on the basis of the position during the searching process, that is, a method for optical wavelength position searching and tracking with variable steps is provided by the present invention; that is, by analyzing a large quantity of the data, it can be found that the optical power will be at the largest value when the optical signal and the optical filter are overlapped completely, and the optical power may be decreased when they are overlapped in completely; the variation of the optical power may be larger in a bandwidth range between the complete overlap and the incomplete overlap, and the variation of the optical power may be smaller when they are not completely overlapped. On the basis of the characteristic of the optical filter, rapid searching with large steps may be used when the power variation can not reach a certain amplitude; and when the power variation reaches a certain amplitude, the steps wilI be modified and a fine searching method with small steps can be used.

In an application of optical wavelength position searching and tracking, the implemtation of the method provided by the present invention has achieved good results; not only the requirement for a rapid searching process is satisfied, but also ensuring to process the optical signal accurately: and the processing cost has not increased.

### BRIEF DESCRIPTION OF THE DRAWINGS

The features of the present invention will be further explained in conjunction with the embodiments and the drawings, wherein:

FIGS. 1A and 1B are flowcharts for implementing physically the method of the present invention.

### DETAILED DESCRIPTION OF THE PREFERRED EMBODIMENTS

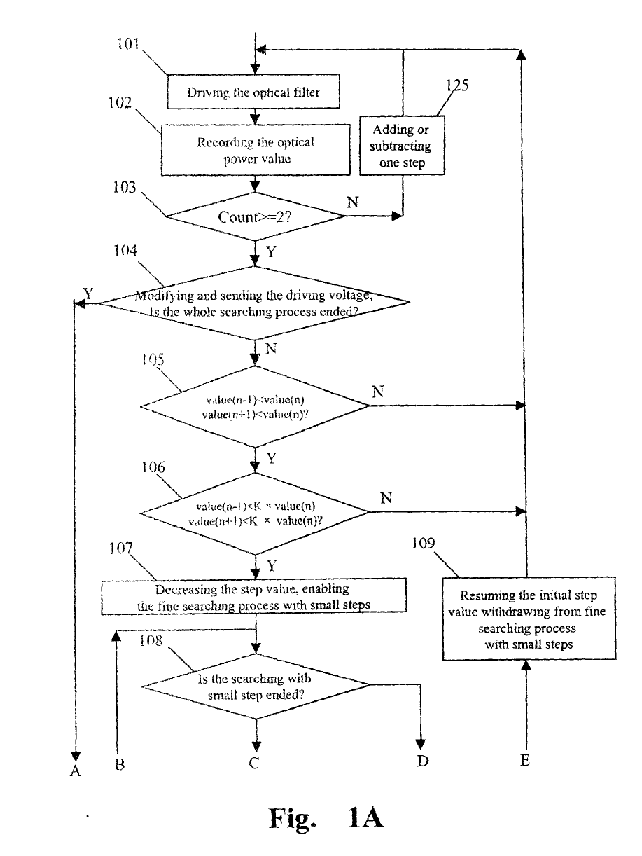

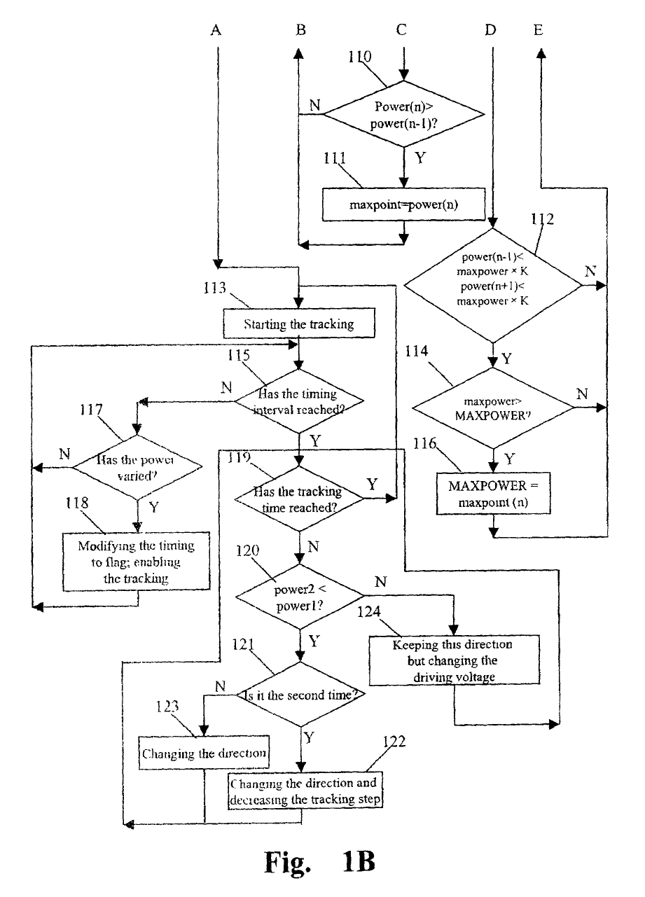

The features of the method of the present invention will be explained in conjunction with a specific embodiment of the present invention with reference to FIG. 1A and 1B. In the flowchart shown in FIG. 1, the definition of the reference characters are as follows:

value [n]: the optical power value of the current point when searching;

value [n−1]: the optical power value of the last point when searching;

value [n+1]: the optical power value of the next point when searching;

power [n]: the optical power value of the current point when tracking;

power [n−1]: the optical power value of the last point when tracking.

maxpower: the maximal value in a small area when fine searching;

MAXPOWER: the largest value in the entire area;

power 1: the power value of the current center point during the tracking process;

power 2: the power value of the current swinging point during the tracking process.

The description of specific implementation processes will be given in below:

1: A driving voltage is applied to the optical filter (block 101); the optical power value after passing through the optical filter at this time is recorded (block 102); then the value of one is added to or subtracted from the driving voltage on the basis of the searching direction (block 125), and the optical filter will be driven again; then the optical power value after passing through the optical filter this time will be recorded again.

2: The above process will be repeated, to record more than three values (block 103), then the condition decision of the recorded values will be started, and after that, the decision will be made once each time a recorded value being added. The condition decision will be carried out in such a way: A recorded value may be taken, then it will be compared with the values before and after it (block 105), if it is larger than the values before and after it, then the decision will be made the second time (block 106), otherwise, the decision will not be made the second time, and the process will return to process 1 (going to block 101) to carried out continuously. The second decision will be made in such a way: A value (K×value [n]) may be calculated for the recorded middle value on the basis of a ratio. If at least one of two recorded values (value [n−1], value [n+1]) before and after the recorded middle value is smaller than the calculated value, then the condition will be satisfied the first time, and two steps will be moved back at this point, then the point moved back will be used as a start point, and the step value will be decreased a large amount (block 107), to enable the fine searching process with small steps and the process will go to process 3; otherwise, it will return to process 1 (block 101) to carry out continuously.

3: A time searching process with small steps: Firstly, whether the number of the fine searching has been reached will be decided (block 108), if it has been reached, then the initial step value may be resumed, and the second decision will be made, as shown in process 4 (block 112, block 114 and block 116). If it has not been reached, then the value will be compared with the values before and after it each time a recorded point being added, if it is larger than the recorded values before and after it (block 110), then the maximal recorded value in the fine searching process with small steps will be refreshed (block 111), otherwise, the recording will not be refreshed, and all of them will returned to process 3 (block 108) to carry out continuously.

4: The second decision will be made in such a way: A value (maxpower ×K) may be calculated for the maximal recorded value of the power on the basis of a ratio, if two recorded values which occur subsequently in N recorded values before and after the middle value are all smaller then the calculated value (block 112) (it should be noted that N is set as a constant), then it is the first time that the conditions are satisfied. Then the maximal value of the power will be compared with the largest value of the power which have been stored during the whole process (block 114); if the maximal value is larger than the largest value, then the largest value and the associated record will be refreshed (block 116), otherwise, the record will not be refreshed. Then, the initial step value may be resumed, and will withdraw from the fine searching process with small steps (block 109) and return to process 1 (block 101) to carry out continuously, until the searching process has been ended in a specific area. The voltage value at the place where the largest power is obtained may be used to drive the optical filter, and it will go to the tracking process (block 113);

5: The tracking processes are as follows:

5A: Firstly, a decision is made on whether the time interval has been reached (block 115), if it has been reached, then the tracking process will be enabled, as shown in 5B; if it has not been reached, then whether the power has been varied may be decided (block 117); if it has not been varied, then it will return to block 115 and repeat 5A; if the power has been varied, then the time interval will be modified, and the tracking process (block 115) will be enabled to enter 5B.

5B: By using the current voltage point as a center point and the tracking step value as the regulation amplitude, the optical filter will swing to a certain direction; if the power value after swinging is larger than the power value of the current operating point (block 120), then it will swing to this direction continuously (block 124); if the power value after swinging is smaller than the power value of the current operating point, then it will swing to another direction (block 123).

5C: By comparing the power value (power 2) after swinging and the power value (power 1) of the current operating point the second time, if the power value is smaller than the power value of the current operating point (power 2<power 1), then the tracking step value will be decreased and the direction will be changed (block 122), and it will return to 5B (block 119) to start the repetition of above process, until the tracking step value is stable at 1, then the tracking process will be ended and 5D will be entered.

If the power value after swinging is larger than the power value of the current operating point, then the tracking step value will be increased and swinging continuously to this direction (block 124), and 5B will be entered to repeat;

5D: The above process will be repeated starting from 5A.

In order to investigate the actual effect of the present invention, in a experimental transmission equipment in which an OTF-610 active tunable optical filter is installed, when the second method in prior art as described in the preceding sections is used for searching the optical wavelength, it is found that when the optical signal is very small, for example near −46 dB, the signal will not be searched at some wavelength position, and sometimes, some false signals will be searched. However, when the method of the present invention is used, in the similar condition that the optical signal is very weak, even it approximates to −50 dB, the optical signal can still be acquired accurately at any position. Under the premise of making the hardware configuration unchanged, the adaptive area is increased.

What is claimed is:

1. A method for optical wavelength position searching and tracking, comprising a position searching the positioning and a tracking process, wherein, in said searching process, if the optical power variation detected in two times can not reach a certain amplitude, then a rapid searching method with large steps will be used; while the optical power variation can reach a certain amplitude, the steps will be modified to utilize fine searching method with small steps.

2. The method according to claim 1, wherein, said position searching process comprising the steps of:
1) the optical power value after passing through the optical filter is recorded at three different driving voltages according to one searching direction, said three different driving voltages are different from each other by one step;
2) under the condition of adding or subtracting a step with certain width to or from the current driving voltage, the optical power after passing through the optical filter will be recorded, and said recorded value will be compared with two recorded values before and after it, if it is larger than two recorded values before and after it, then step 3) will be performed, otherwise, it will return to step 1);
3) a value may be calculated for the recorded middle value on the basis of a ratio, if at least one of two recorded values before and after the recorded middle value is smaller than the calculated value, then the condition will be satisfied the first time, and two steps will be moved back at this point, and the point moved back will be used as a start point, while the step value is decreased a large amount to enable, the fine searching process with small steps, and the fine searching process (that is, step 4)) with small steps will be performed, otherwise, it will return to implement step 1);
4) Firstly, whether the number of times for fine searching has reached may be decided, if it has reached, then the initial step value will be resumed, and the second decision will be carried out, and will go to step 5); if it has not reached, then every recorded point added newly will be compared with two recorded value before and after it, if it is larger than two recorded values before and after it, then the maximal recorded value in the fine searching process with small steps will be refreshed, otherwise, the record will not be refreshed, and the present step will be repeated; and
5) a value may be calculated for the maximal recorded value of the power on the basis of a ratio, if the subsequent two recorded values which occur in N (N is set as a specific constant) recorded value before and after the middle value is smaller than the calculated value, then the condition will be satisfied the first time, and said maximal value of the power will be compared with the largest value of the power stored during the entire process, if the maximal value is larger than the largest value, then the largest value and the associated record will be refreshed, otherwise, the record will not be refreshed, then the initial step value may be resumed, it will withdraw from the fine searching process with small steps and return to step 1 to carry out continuously, until the searching is ended in a specific area; the voltage value at the largest power will be used to drive the optical filter, and it will go to the tracking process.

3. The method according to claim 1 or 2, wherein, said tracking process comprising the steps of:
1) firstly, whether the time interval has reached may be decided, if the time interval has reached, then step 2) will be performed; if the time interval has not reached, then whether the power has changed will be decided, if it has not changed, then step 1) will be repeated, if it has changed, then the time interval will be modified, and the tracking process will be enabled to go to step 2);
2) by using the current voltage point as a center point, and the tracking step value as a regulation amplitude, the optical filter may be allowed to swing at a certain direction, if the power value after swinging is larger than the power value of the current operating point, then it will be swung continuously to this direction; if the power value after swinging is smaller than the power value of the current operating point, then the direction of swinging will be changed; and
3) by comparing the power value after swinging and the power value of the current operating point the second time, if the power value after swinging is smaller than the power value of the current operating point, then the tracking step value will be decreased and the direction will be changed, and the process will be repeated continuously by starting from step 2), until the tracking step value is stable at 1, then the tracking will be ended; if the power value after swinging is larger than the power value of the current operating point, then the tracking step value will be increased, and it will be swung continuously to this direction, and will go to step 2) again.
